(19) United States
(12) Patent Application Publication
(10) Pub. No.: US 2011/0013584 A1
(43) Pub. Date: Jan. 20, 2011

(54) METHOD TO ALLOCATE TRANSMISSION RESOURCES IN A CELL NETWORK OF COOPERATIVE TYPE

(75) Inventors: Emilio Calvanese Strinati, Grenoble (FR); Cédric Abgrall, Grenoble (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Comm. a I' ener. atom. et aux energies alter., Paris (FR)

(21) Appl. No.: 12/833,284

(22) Filed: Jul. 9, 2010

(30) Foreign Application Priority Data
Jul. 20, 2009 (FR) 09 55024

(51) Int. Cl. H04W 72/04; H04J 3/00

(52) U.S. Cl. 370/330; 370/336

(57) ABSTRACT

The invention concerns a method to allocate transmission resources in a cell network of cooperative type. Each cell comprises a source, a receiver and optionally a half-duplex relay to relay data transmitted by the source to the receiver. The invention draws advantage from the half-duplex mode of a relay belonging to a cell, by allocating to the source of a neighbouring cell a resource used by this relay during one same transmission timeslot.

### TECHNICAL AREA

The present invention generally concerns the area of cell telecommunications and more particularly those using a cooperation strategy.

### STATE OF THE PRIOR ART

One promising technique that has recently been investigated in the sphere of new telecommunications standards for wireless mobiles, such as WiMax, 3GPP LTE (3GPP Long Term Evolution) to increase the coverage and throughput of conventional cell networks, is a cooperation strategy technique deployed at the base stations or at the mobile terminals.

Examples of cell networks using a cooperation strategy can be found in the article by S. Shamai et al. titled “Cooperative multi-cell networks: impact of limited capacity backhaul and inter-user links” published in Proc. of the Joint Workshop on Coding and Communications, Austria, Oct. 14-16, 2007, and in the article by C. Hoymann et al. titled “Flexible Relay Wireless OFDM-based Networks” published in Proc. of 15th IST Mobile and Wireless Communication Summit, June 2006.

Base station cooperation called MCP for Multi-Cell Processing amounts to using a distributed antenna system of the type Multiple Input Multiple Output (MIMO) with joint encoding/decoding of transmitted/received signals by the different antennas. The drawback with this cooperation strategy, however, is that it overloads the backhaul network connecting the base stations.

Cooperation at the mobile terminals translates as the fact that some terminals act as relays for receiver terminals, whether for uplinks or for downlinks. It has also been proposed that some dedicated fixed relays should be installed in a cell to carry out this role.

Hereunder, we shall use the expression “relay cooperation” to designate either one of these techniques indifferently, the relay in both cases receiving a signal from a source (base station for downlinks and terminal for uplinks) and re-transmitting it to a receiver (base station for uplinks and terminal for downlinks).

The relay may retransmit the source signal in full-duplex or half-duplex mode. Conventionally, in full-duplex mode the relay is capable of receiving and transmitting simultaneously on one same source, whereas in half-duplex mode the relay is successively in a receive phase and a transmit phase on a given resource.

One example of cooperation using relays operating in half-duplex mode is described in the article by O. Simeone et al. titled “Uplink throughput of TDMA cellular systems with multicell processing and Amplify- and Forward cooperation between mobiles” published in IEEE Trans. on Wireless Communications, Vol. 6, N° 8, pages 2942-2951, August 2007.

FIG. 1 is a very schematic view of a cooperation cell network via half-duplex relay. Two adjacent cells 110 and 120 are shown.

In cell 110, a source s₁ (here a mobile terminal) transmits a flow of data to a destination receiver d₁, (here the base station B₁.) The relay r₁ (here a mobile terminal) also receives the flow of data derived from s₁ and relays the same to the receiver d₁. The relay r₁ therefore cooperates with transmission of data between s₁ and d₁. For example, if the channel s₁-d₁ is of poor quality, notably on account of the presence of an obstacle between s₁ and d₁, the channel s₁-r₁-d₁ can allow the obstacle to be by-passed and to obtain satisfactory quality of communication. The flow of data can be relayed by several terminals to further increase the spatial diversity of the transmission pathways. In addition, it can be relayed in a single time (single-hop) or in several consecutive times (multiple-hop).

Similarly, the cell 120 comprises a source s₂ (here the base station B₂) which transmits a flow of data to the receiver d₂ (here a mobile terminal) both directly and via the relay r₂ (here a mobile terminal).

The relay terminal r₁ receives data from the source terminal s₁ during a listening phase and retransmits the data towards the base station during a transmission phase. The receiver base station therefore receives the same data, via different pathways, a first time during the transmission time slot from the source terminal and a second time during the transmission time slot from the relay terminal. Cooperation is identical within cell 120, the only difference being that here the source is the base station B₂ and the receiver is a mobile terminal.

Cell networks using relay cooperation raise new problems in terms of inter and intra-cellular interference. In conventional cell networks, it is known to allocate separate transmission resources (e.g. frequencies) to adjacent cells, and to re-use these sources along a predetermined pattern (frequency reuse pattern) when the cells are distant. Therefore, for a given number of transmission resources, the level of inter-cell interference is reduced which is particularly critical on the periphery of a cell.

It is possible to use said resource allocation pattern in a cell network with cooperation via half-duplex relay. However, since the number of connections is substantially higher therein than in a conventional cell network, this allocation strategy would be heavy on transmission resources, as explained below.

FIGS. 2A and 2B schematically illustrate a method to allocate transmission resources in a cell network, respectively with and without cooperation via half-duplex relay.

The transmission timeslots relating to the different terminals are given along the X-axis and another transmission resource e.g. frequency chunks δf₁ and δf₂ for an OFDM system is given along the Y-axis.

When there is no cooperation, cf. FIG. 2A, (the relays r₁ and r₂ are absent or inactive), the sources s₁ and s₂ transmit their flow of data during transmission timeslots T₁ and T₂ by modulating the sub-carriers respectively belonging to the frequency chunks δf₁ and δf₂. The designations s₁(T₁) and s₂(T₂) are used to denote the respective data transmitted by s₁ and s₂ during the timeslots T₁ and T₂.

When cooperation exists, cf. FIG. 2B, the sources s₁ and s₂ transmit their flow of data as previously during the transmission timeslot T₁ on chunks δf₁ and δf₂. The half-duplex relays r₁ and r₂ are in listening phase, respectively on δf₁ and δf₂ during timeslot T₁, and retransmit the received data during timeslot T₂ for example using the same frequency chunks δf₁ and δf₂. The designations r₁(T₁) and r₂(T₁) are used to denote the data transmitted r₁ and r₂ during timeslot T₁.

FIG. 2C illustrates a method to allocate resources when only one of the two adjacent cells, here 110, uses a cooperation strategy.

Allocation during the transmission timeslot T₁ is identical to the allocation illustrated FIG. 2A or 2B. On the other hand, during the transmission timeslot T₂, the relay r₁ relays the data received from s₁ using the frequency chunk δf₁ and s₂ continues to transmit its data using the frequency chunk δf₂.

It will be understood that, to transmit the same quantity of data, it is necessary to use two times more transmission resources in the cooperation configuration shown FIG. 2B than in the configuration without cooperation shown FIG. 2A. Similarly, it will be necessary to use one and a half times more resources in the mixed cooperation configuration shown FIG. 2C than in the configuration without cooperation shown FIG. 2A.

The object of the present invention is therefore to propose a resource allocation method for a cell network with half-duplex relay cooperation which guarantees a low level of inter-cell interference without, however, mobilizing a major number of transmission resources.

### DISCLOSURE OF THE INVENTION

The present invention is defined by a method to allocate resources in a cell network comprising at least two adjacent cells, a first cell comprising a first source, a first relay and a first receiver, and a second cell comprising at least one second source and a second receiver. A first transmission resource is allocated to the first relay during a first transmission timeslot during which the relay retransmits data to the first receiver that was previously received from the first source during at least one preceding transmission timeslot, and said first resource is also allocated to said second source during said first transmission timeslot.

According to one particular embodiment, the second cell comprises a second relay and a second transmission resource is allocated to it during a second transmission timeslot during which it retransmits data to the second receiver that was previously received from the second source during at least one preceding transmission timeslot, said second resource also being allocated to said first source during said second transmission timeslot.

Said first and second transmission timeslots can be chosen to be identical or separate.

According to a first example of embodiment, a first and a second frequency chunk are allocated to the first and second sources respectively and, during each transmission timeslot, the first relay is allocated the second frequency chunk on which to retransmit the data it received from the first source on the first frequency chunk during the preceding transmission timeslot.

According to a second example of embodiment, a first and a second frequency chunk are allocated to the first and second sources respectively, during a current transmission timeslot, and this allocation is permutated during the following transmission timeslot. Additionally, during the current transmission timeslot, the first relay is allocated the second frequency chunk on which to transmit the data that it received from the first source during the preceding transmission timeslot on the second frequency chunk, and during the following transmission timeslot the first relay is allocated the first frequency chunk on which to retransmit the data from the first source that it received during the current transmission timeslot on the first frequency chunk.

According to a third example of embodiment, the second transmission timeslot follows the first transmission timeslot, and a first and a second frequency chunk are allocated to the first and second sources respectively during the first transmission timeslot, the second frequency chunk also being allocated to the first relay during the first transmission timeslot to retransmit the data received from the first source during the preceding transmission timeslot, the first frequency chunk also being allocated to the second relay during the second transmission timeslot to retransmit the data received from the second source during the first transmission timeslot.

According to a fourth example of embodiment, a first and a second frequency chunk are allocated to the first and second sources respectively. During a transmission timeslot, the first and second relays receive data from the first and second sources respectively, and during the following transmission timeslot the first and second relays are respectively allocated the first and the second frequency chunk on which to retransmit the data received from the first and second sources respectively.

According to a fifth embodiment, the first and the second source are respectively allocated a first and a second frequency chunk during a current transmission timeslot, and this allocation is permutated during the following transmission timeslot. During the current transmission timeslot, the first relay is allocated the second frequency chunk on which to transmit the data it received from the first source on the second frequency chunk during the preceding transmission timeslot, and the second relay is allocated the second frequency chunk on which to retransmit the data it received from the second source on the first frequency chunk during the preceding transmission timeslot. During the following transmission timeslot, the first relay is allocated the first frequency chunk on which to retransmit the data from the first source that it received during the current transmission timeslot on the first frequency chunk, and the second relay is allocated the second frequency chunk to retransmit the data from the second source that it received during the current transmission timeslot on the second frequency chunk.

According to a sixth example of embodiment, at each transmission timeslot, the first and the second sources are respectively allocated a first and a second frequency chunk and, during this same timeslot, the first relay is allocated the second frequency chunk on which to retransmit the data it received from the first source on the first frequency chunk during the preceding transmission timeslot, and the second relay is allocated the second frequency chunk on which to retransmit the data it received from the second source on the second frequency chunk during the preceding transmission timeslot.

### BRIEF DESCRIPTION OF THE DRAWINGS

Other characteristics and advantages of the invention will become apparent on reading one preferred embodiment of the invention given with reference to the appended figures amongst which:

FIG. 1 schematically illustrates a cooperation cell network via relay known in the prior art;

FIGS. 2A and 2B respectively illustrate an allocation of resources with and without relay cooperation in to adjacent cells;

FIG. 2C illustrates an allocation of resources in a configuration with relay cooperation in only one of the two adjacent cells;

FIGS. 3A and 3B schematically illustrate two examples of allocation of resources according to the invention for a cell network having relay cooperation in only one of the adjacent cells;

FIGS. 3C to 3E schematically illustrate examples of allocation of resources according to the invention for a cell network having relay cooperation in two adjacent cells.

### DETAILED DESCRIPTION OF PARTICULAR EMBODIMENTS

A cell network of cooperative type is again considered in which the cooperation strategy has recourse to relays operating in half-duplex mode. Therefore, each cell may comprise a group of sources, a group of receivers and a group of relays, this latter group being empty if no cooperation via relay is envisaged in the cell under consideration. When a cell served by a base station is itself divided into sectors or micro-cells and if an allocation of resources is provided in each sector/micro-cell, it is understood, without any loss of general meaning, that the term “cell” shall apply to the basic entity in which the allocation of resources is made.

In general, the cell network uses transmission resources which may be transmission timeslots (cf. TDMA system), frequencies (cf. FDMA system), frequency chunks (cf. OFDMA system), orthogonal codes (cf. CDMA system) or combinations of said resources.

In one preferred embodiment relating to the OFDMA system, the resources are chosen to be transmission timeslots and frequency chunks, more precisely groups of sub-carriers of an OFDM multiplex.

One first idea at the root of the invention is that the cooperation strategy via relay is only efficient insofar as the channel between the source and the relay only has low interference. If there is interference on the channel, the signal that is decoded then retransmitted (relay of decode and forward type) or the amplified then retransmitted signal (relay of amplify and forward type) may be of poor quality. It follows that the signal-to-noise ratio at the receiver end is lower than in the case without cooperation.

A second idea at the root of the invention is to draw advantage from the half-duplex functioning of the relays under consideration. More precisely, when said relay is in transmission phase on a given resource e.g. a frequency band, it cannot receive on this resource at the same time. This resource can then be simultaneously allocated to another source in a neighbouring cell. Even if this allocation induces interference on the channel between the relay and the receiver, this interference will be less penalizing in terms of signal-to-noise ratio at the receiver end than if it had occurred on the channel between the source and the relay.

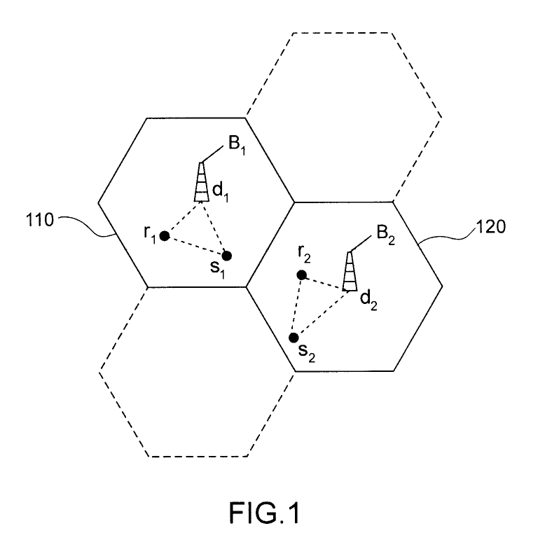

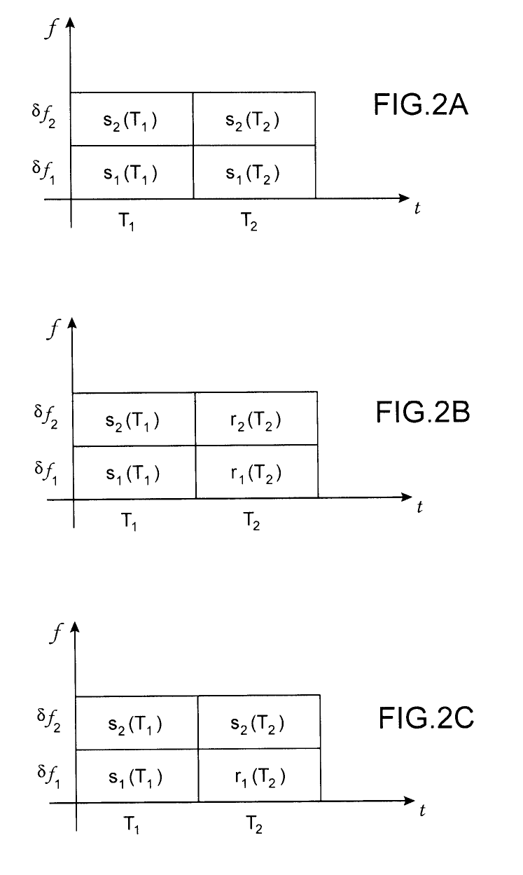

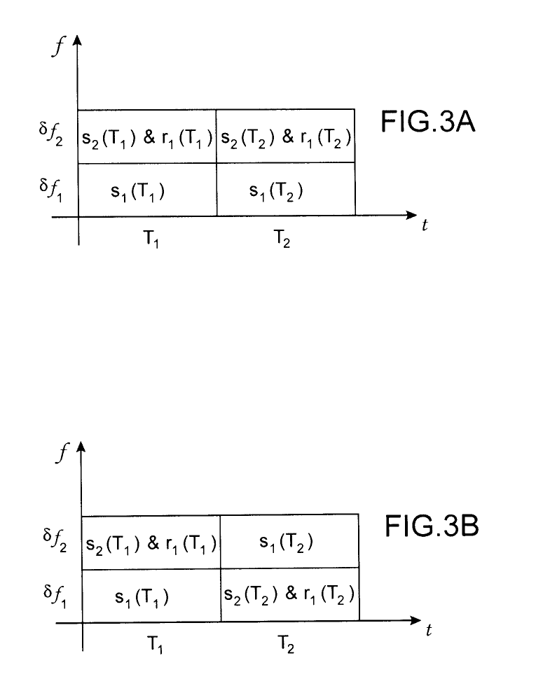

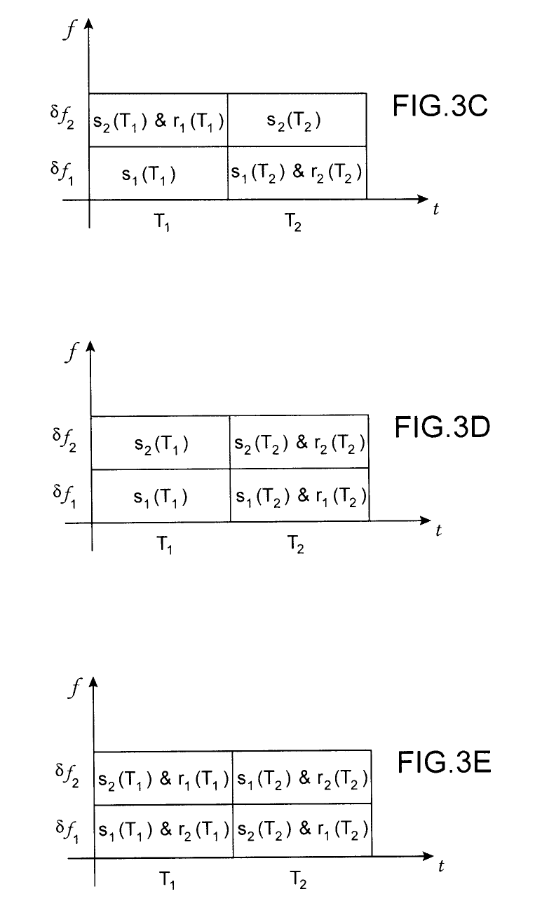

FIG. 3A illustrates an example of allocation of resources according to the invention in a cell network with relay cooperation, such as the one shown in FIG. 1. It is assumed here that only cell 110 uses relay cooperation, in other words relay r₂ is absent or inactive.

During timeslot T₁, the source s₁ transmits its data on resource δf₁ and source s₂ transmits its data on resource δf₂. In the same timeslot, the relay r₁ receives data from s₁ on resource δf₁ and transmits the data on resource δf₂ that it previously received during the preceding timeslot (here T₀). As previously, s₁(T₁) is used to designate the data transmitted by the source s₁ during timeslot T₁ and r₁(T₁) designates the data retransmitted by relay r₁ during timeslot T₁. In half-duplex mode, a relay is capable of receiving on a first resource, for example δf₁ and of transmitting simultaneously on a second resource δf₁≠δf₁. It is to be noted that the data retransmitted by the relay is not necessarily retransmitted in identical form to the data it received. Received data may for example be decoded then re-encoded.

During timeslot T₂, the allocation of resources is identically repeated and relay r₁ transmits the data on resource δf₂ that it received on resource δf₁ during timeslot T₁.

It will therefore be understood that the channel s₁-r₁ using δf₁ is never interfered by the communication between s₂ and d₂ using δf₂.

FIG. 3B gives another example of allocation according to the invention for the same cooperation configuration as shown in FIG. 3A.

Unlike the preceding allocation pattern, the allocation of resources δf₁ and δf₂ is reversed between the first and second timeslots. More precisely, during timeslot T₂, relay r₁ receives data from s₁ on resource δf₂ and transmits on resource δf₁ the data it received from s₁ on resource δf₁ during timeslot T₁.

Therefore, relay r₁ receives and transmits alternately on either resource unlike the pattern illustrated in FIG. 3A. However, as previously, it will be noted that the channel s₁-r₁ is not interfered by the communication between s₂ and d₂.

FIG. 3C illustrates an example of allocation of resources according to the invention in a cell network using cooperation via relays in two adjacent cells 110 and 120.

The allocation of resources during timeslot T₁ is identical to the allocation shown in FIGS. 3A and 3B. In other words, the sources s₁ and s₂ transmit their data respectively using the resources δf₁ and δf₂, and relay r₁ retransmits on resource δf₂ the data it received from s₁ during timeslot T₀. On the other hand, unlike the preceding allocation patterns, the relay r₂ transmits during timeslot T₂ on resource δf₁ the data it previously received during the preceding timeslot on resource δf₂.

It will therefore be understood that there is never any interference on the channels and s₁-r₁ and s₂-r₂. On the other hand, cooperation is only effective every other time insofar as the relays only receive during one out of every two timeslots. In the illustrated example, the relay r₁ does not receive during timeslot T₂ but only during timeslot T₁. Similarly, relay r₂ does not receive during timeslot T₁ but only during timeslot T₂.

According to one variant not shown, the relays r₁ and r₂ receive permanently on resources δf₁ and δf₂ respectively. During timeslot T₁, relay r₁ transmits the data on resource δf₂ that it previously received from s₁ during timeslots T₁ and T₀. Similarly, during timeslot T₂ the relay r₂ transmits on resource δf₁ the data that it previously received from s₂ during timeslots T₀ and T₁. It is to be noted however that during timeslot T₁, channel s₂-r₂ is interfered by retransmission of r₁, and during the timeslot T₂ channel s₁-r₁ is interfered by the retransmission of r₂. In addition, the data must be retransmitted by the relays at a rate that is twice higher than the rate of the sources.

FIG. 3D shows another example of resource allocation according to the invention. The situation of relay cooperation is the same as the one envisaged FIG. 3C.

During the first transmission timeslot T₁, the source s₁ transmits its data using resource Δf₁ and the source s₂ transmits its data using resource δf₂. The relays r₁ and r₂ respectively receive the data from s₁ and s₂ during T₁ and retransmit the same during T₂ on the resources δf₁ and δf₂ respectively. The sources continue to transmit their data on these same resources during the second transmission timeslot.

Therefore, there is no interference on channels s₁-r₁ and s₂-r₂ either during T₁ or during T₂.

FIG. 3E illustrates a last example of allocation of resources according to the invention. The cooperation situation via relays is here again the same as the one envisaged in FIG. 3C.

During the transmission timeslot T₁, the sources s₁ and s₂ transmit their respective data on resources δf₁ and δf₂. Relay r₁ receives data from s₁ on resource δf₁ and retransmits on resource δf₂ the data previously received from this source during timeslot T₀. In similar manner, the relay r₂ receives data from s₂ on resource δf₂ during this timeslot and retransmits on resource δf₁ the data previously received from this source during timeslot T₀.

During timeslot T₂, the allocation of resources is reversed both for the sources s₁ and s₂ and for the relays r₁ and r₂. In other words, the sources s₁ and s₂ transmit their respective data on resources δf₂ and δ₁. The relay r₁ receives the data from s₁ on resource δf₂ and retransmits on resource δf₁ the data previously received during timeslot T₁. Similarly, the relay r₂ receives the data from s₂ on resource δf₁ and retransmits on resource δf₂ the data previously received during timeslot T₁.

During timeslot T₁ or timeslot T₂ the channel s₁-r₁ is only interfered by retransmission of r₂ and channel s₂-r₂ is only interfered by retransmission of r₁.

According to one variant not shown in the example illustrated in FIG. 3E, the allocation of resources during the second timeslot is chosen to be identical to the allocation of the first timeslot.

In all the above-cited examples, use is made of the half-duplex mode of a relay belonging to one cell, by allocating to a source of an adjacent cell the resource used by this relay during the same transmission timeslot.

Although the present invention has been described above with respect to two neighbouring cells, the person skilled in the art will understand that it may be extended without any difficulty to any number of such cells. Similarly, although the present invention has been illustrated with two transmission timeslots and more generally with two transmission resources for two sources, the person skilled in the art will appreciate that it applies generally to any number of transmission resources for a plurality of sources.

1. Method to allocate resources in a cell network comprising at least two adjacent cells (110, 120), a first cell (100) comprising a first source (s₁), a first relay (r₁) and a first receiver (d₁) and a second cell (120) comprising at least a second source (s₂) and a second receiver (d₂), characterized in that a first transmission resource is allocated to the first relay during a first transmission timeslot in which this relay retransmits to the first receiver the data previously received from the first source during at least one preceding transmission timeslot, and in that said first resource is also allocated to said second source during said first transmission timeslot.

2. Method to allocate resources according to claim 1, characterized in that the second cell comprises a second relay and in that a second transmission resource is allocated to it during a second transmission timeslot in which it retransmits to the second receiver the data previously received from the second source during at least one preceding transmission timeslot, said second resource also being allocated to said first source during said second transmission timeslot.

3. Method to allocate resources according to claim 2, characterized in that said first and second transmission timeslots are identical.

4. Method to allocate resources according to claim 2, characterized in that said first and second transmission timeslots are separate.

5. Method to allocate resources according to claim 1, characterized in that the first and second sources are respectively allocated a first and a second frequency chunk (δf₁, δf₂), and in that during each transmission timeslot (T₁,T₂) the first relay is allocated the second frequency chunk (δf₂) on which to transmit the data it received from the first source on the first frequency chunk (δf₁) during the preceding transmission timeslot (T₀,T₁).

6. Method to allocate resources according to claim 1, characterized in that the first and second sources are respectively allocated a first and a second frequency chunk (δf₁, δf₂) during a current transmission timeslot (T₁), and in that this allocation is permutated during the following transmission timeslot (T₂), in that the first relay during the current transmission timeslot is allocated the second frequency chunk (δf₂) on which to transmit the data it received from the first source during the preceding transmission timeslot on the second frequency chunk (δf₂), and in that the first relay during the following transmission timeslot (T₂) is allocated the first frequency chunk (δf₁) on which to retransmit the data from the first source that it received during the current transmission timeslot (T₁) on the first frequency chunk (δf₁).

7. Method to allocate resources according to claim 4, characterized in that the second transmission timeslot follows the first transmission timeslot, and in that the first and the second sources are respectively allocated a first and a second frequency chunk (δf₁, δf₂) during the first transmission timeslot (T₁), the second frequency chunk (δf₂) also being allocated to the first relay during the first transmission timeslot to retransmit the data (r₁(T₀)) received from the first source during the preceding transmission timeslot (T₀), the first frequency chunk (δf₁) also being allocated to the second relay during the second transmission timeslot to retransmit the data (r₂(T₁)) received from the second source during the first transmission timeslot (T₁).

8. Method to allocate resources according to claim 3, characterized in that the first and second sources are respectively allocated a first and a second frequency chunk (δf₁, δf₂), and in that during a transmission timeslot (T₁) the first and second relays receive data from the first and second sources respectively, and in that during the following transmission timeslot the first and the second relay are respectively allocated the first and the second frequency chunk on which to retransmit the data received respectively from the first and the second sources.

9. Method to allocate resources according to claim 3, characterized in that the first and second sources are respectively allocated a first and a second frequency chunk (δf₁, δf₂) during a current transmission timeslot (T₁), and in that this allocation is permutated during the following transmission timeslot (T₂), in that during the current transmission timeslot the first relay is allocated the second frequency chunk (δf₂) to retransmit the data it received from the first source on the second frequency chunk (δf₂) during the preceding transmission timeslot (T₀), and the second relay is allocated the second frequency chunk (δf₂) on which to retransmit the data it received from the second source on the first frequency chunk (δf₁) during the preceding transmission timeslot (T₀) and in that during the following transmission timeslot (T₂), the first relay is allocated the first frequency chunk (δf₁) on which to retransmit the data from the first source that it received during the current transmission timeslot (T₁) on the first frequency chunk (δf₁) and the second relay is allocated the second frequency chunk (δf₂) on which to retransmit the data from the second source that it received during the current transmission timeslot (T₁) on the second frequency chunk (δf₂).

10. Method to allocate resources according to claim 3, characterized in that at each transmission timeslot (T₁), the first and second sources are respectively allocated a first and a second frequency chunk (δf₁, δf₂), and in that during this same timeslot the first relay is allocated the second frequency chunk (δf₂) on which to retransmit the data it received from the first source on the first frequency chunk (δf₁) during the preceding transmission timeslot (T₀), and the second relay is allocated the second frequency chunk (δf₂) on which to retransmit the data it received from the second source on the second frequency chunk (δf₂) during the preceding transmission timeslot (T₀).
